(19) United States
(12) Patent Application Publication
(10) Pub. No.: US 2003/0221951 A1
(43) Pub. Date: Dec. 4, 2003

(54) Two-electrode corona apparatus for plastic throttle body surface treatment

(75) Inventors: Xiaolu Chen, Saline, MI (US); Charles M. Freitas, Chelsea, MI (US); Wade Coots, Livonia, MI (US); Zili Wu, Orefield, PA (US)

Correspondence Address: BRINKS HOFER GILSON & LIONE, P.O. BOX 10395, CHICAGO, IL, 60611, US

(73) Assignee: Visteon Global Technologies, Inc.

(21) Appl. No.: 10/160,077

(22) Filed: May 29, 2002

(51) Int. Cl. B01J 19/08

(52) U.S. Cl. 204/165; 422/186.05; 264/483

(57) ABSTRACT

Provided is an apparatus for surface treatment of a throttle body structure with a first and a second electrode located in a housing electrically connected to a transformer. A rotating fixture base is also provided in the housing.

Also provided is a method for surface treatment of a throttle body structure utilizing the above apparatus and a provided throttle body. A throttle body structure is provided and secured to said fixture base. The two electrodes are lowered into an engaged position in the center of the throttle body. Air is pumped towards the electrodes and voltage from the transformer is applied to the electrodes. The fixture base and throttle body are rotated. After treatment, the electrodes are then returned to the home position.

### BACKGROUND OF THE INVENTION

Plastic structures, while lightweight, have particularly low adhesive qualities. While equivalent metal structures will easily allow coating, foams or other such materials to adhere to its surface, the low surface energy level inherent in most plastics do not afford that luxury. There are many applications in which the ability to adhere a substance to a plastic structure is highly desirable. For example, in the field of vehicle mechanics, it would be desirable to make a throttle body out of plastic.

The throttle body structure is particularly critical to vehicle operation. The throttle, contained in the throttle body structure, serves to regulate air flow to the engine and is coupled to the acceleration system of the vehicle. In addition, the throttle is related to the idling speed of the vehicle. For more efficiency, a vehicle engine should have the lowest possible idle speed while maintaining an idle speed above the stalling speed of the vehicle engine. The throttle body should therefore be as airtight as possible, as an airtight throttle body will allow the throttle to more efficiently regulate air flow. If the throttle body is not airtight, there will be air flow loss through the unsealed throttle body and the throttle will not operate properly. Metallic throttle bodies have been treated with a sealant in order to make them more airtight. Plastic throttle bodies, while more lightweight than metal throttle bodies, do not allow the sealant to adhere correctly. To allow a plastic throttle body to accept the sealant, it is necessary to treat the plastic surface to improve its adhesive qualities.

Standard methods of surface treatment, such as flame treatment methods, have had only marginal effectiveness. Such treatments are limited as to the shape and size of the part to be treated. For example, irregularly shaped pieces are particularly difficult to treat. Sharp corners and imperfections hamper the effectiveness of the treatment. Large pieces are more difficult to treat than smaller pieces. Further, the high cost of such a process can be prohibitive.

Corona methods have also been used, and are well known in the art. Corona treatment consists of creating an electric field, either between an electrode and a ground, or between two electrodes. The most common method of increasing surface energy in plastic films, the corona treatment involves applying a high frequency, high-voltage charge that ionizes the surrounding air. The ionized particles in the corona are discharged and contact the film surface, leading to an increase in surface energy as a result of surface oxidation. Increasing the surface energy of a plastic film helps inks and coatings wet the film, as opposed to forming droplets on the surface. Corona treatment also enhances adhesion when thermally applying film to another substrate.

A single electrode can be used to create the corona in combination with a ground, such as a grounded table. Such a system is disclosed is U.S. Pat. No. 5,466,423. However, a single electrode system creates a difficult to control corona. Most specifically, any metal piece, such as a screw or stud, in an otherwise plastic throttle body will attract and misdirect the corona. Throttle bodies must therefore be fully disassembled before treatment, with all metallic parts removed, wasting assembly time.

A double electrode corona system aids the problem of corona control. The two electrodes form a completed electrical circuit and the corona is not misdirected by metallic substances. However, such systems are extremely large, and require a large amount of manpower to control. Such a system may take up over 80 square feet of valuable factory space. It also includes assembly-line-style conveyor belts as well as requiring significant supervision. Such a system would be inappropriate for a lean manufacturing operation.

### BRIEF SUMMARY OF THE INVENTION

According to one embodiment of the present invention, there is provided an apparatus for surface treatment of a throttle body structure, having a first and a second electrode electrically connected to a transformer configured to generate voltage between the electrodes. A housing surrounds the electrodes and transformer, and also houses a rotating fixture base.

According to another embodiment of the present invention, there is provided a method for surface treatment of a throttle body structure. The apparatus provided includes a housing containing first and second electrode connected to a discharge head, a transformer electrically connected to the discharge head, an air blower attached to the discharge head via an air pipe, a pneumatic slide attached to the housing and the discharge head, and a fixture base. A control panel is connected to the pneumatic slide and the transformer. A throttle body structure is provided and secured to said fixture base. The control panel is operated such that the discharge head and the two electrodes are lowered into an engaged position in the center of the throttle body via the pneumatic slide. Air is pumped through the air blower and air pipe towards the electrodes. Voltage from the transformer is applied to the electrodes, and the fixture base and throttle body are rotated. The discharge head and electrodes are then returned to the home position.

Other aspects of the present invention will become apparent in connection with the following description of the present invention.

### BRIEF DESCRIPTION OF SEVERAL VIEWS OF THE DRAWINGS

FIG. 1A is a front-view of the double corona surface treatment apparatus according to the present invention;

FIG. 1B is a side view of the double corona surface treatment apparatus according to the present invention;

FIG. 2 is a flow diagram of a preferred embodiment of the present method; and

FIG. 3 is a magnified view of the “home” and “engaged” positions of the apparatus according to the present invention.

### DETAILED DESCRIPTION OF THE INVENTION

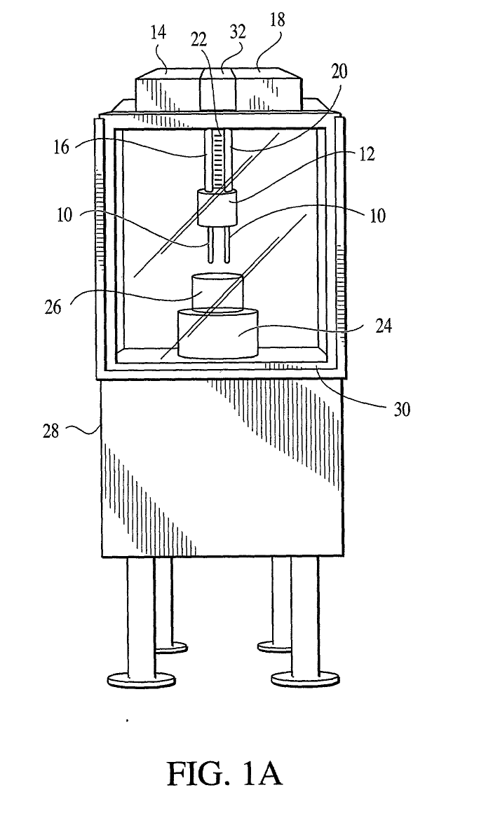

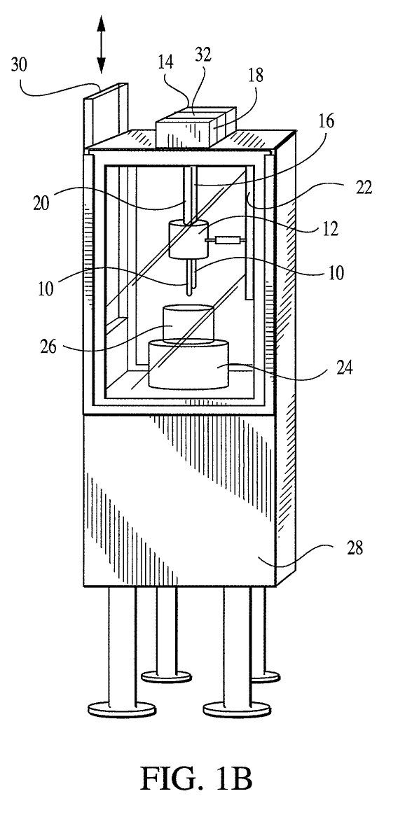

FIG. 1A depicts a two dimensional, front-view diagram of a first embodiment of double corona treatment apparatus in accordance with the present invention. FIG. 1B shows the same apparatus from a side view. Two electrodes 10 are held in a discharge head 12. The electrodes are made of tungsten, aluminum, stainless steel, or another electrically conductive metal able to withstand high temperatures. In FIG. 1A, the electrodes 10 are depicted as cylindrical bars. However, the electrodes 10 may have other geometries, such as cylindrical bars with a pointed end, cylindrical bars with a rounded end, spikes, or hooks. The choice of geometry is dependent on the application for which the apparatus is to be used, as is well known in the art.

In a preferred embodiment, cylindrical bars or hooks are used. The electrodes 10 are inserted into the discharge head 12. The electrodes 10 are spaced apart at a predetermined distance from each other, as known to one of skill in the art. In a preferred embodiment, the discharge head 12 may be designed to allow the spacing between the electrodes 10 to be modified. The discharge head 12 is made of an insulating material, such as a rubber material, so that any voltage that runs through the electrodes 10 remains in the electrode 10 and does not leak into the discharge head 12.

The discharge head 12 is further connected to a transformer 14 through a high voltage line 16. The transformer 14 typically in this embodiment produces a line voltage of between about 8 kV to about 200 kV, preferably about 12 kV. Of course, other voltages may be used. The voltage created by the transformer 14 is discharged to the electrode 10 through the discharge head. Preferably, this is done by connecting the high voltage line 16 to one electrode 10 through the discharge head 12. The other electrode 10 is connected to the high voltage line 16 to return the voltage to the transformer 14. A complete circuit is therefore made, with a gap defined between the two electrodes 10. When voltage is applied to the circuit from the transformer 14, the electricity bridges the gap between the electrodes 10 by forming a corona.

The discharge head 12 is also attached to an air blowing unit 18 via an air pipe 20. The air pipe 20 is preferably made of a flexible rubber tubing material. The air pipe 20 is connected to and passes through the discharge head 12 such that air is preferably blown out between the two electrodes 10, and directed to blow through the corona.

The discharge head 12 is in turn connected to a pneumatic slide 22. The pneumatic slide 22 is configured to move in a vertical direction, moving the discharge head 12 with it. Such a pneumatic slide is well known in the art.

Underneath the electrodes 10 and discharge head 12 is a fixture base 24 for holding a throttle body 26 during the double-corona treatment. Preferably, the fixture base 24 comprises a clamp or other type of positioning lock, as is well known in the art, to hold the throttle body structure 26 to the fixture base 24 while the treatment is progressing. The fixture base 24 is further configured to be able to rotate around its center axis. This fixture base 24 preferably has a maximum rotational speed of at least about 72 degrees/second, so that the fixture base 24 can make a complete rotation in about 5 seconds. Further, the fixture base 24 should be made of an insulating material, such as a rubber material. This will assure that the base fixture 24 does not provide a grounding conduit to affect the corona treatment The entire apparatus, except for the transformer 14 and the air blowing unit 18, is preferably positioned inside a housing 28. Because of the compact design of the treatment apparatus, the housing can be designed to take up as little as 4 square feet of floor space. The housing has on a front surface a safety door 30. The safety door 30 can be better seen in the side view of FIG. 1B, where it is shown open. The safety door 30 can be configured to slide up, as shown in FIG. 1B, or it can be configured to open from the side or bottom. A safety door sensor is also installed in the housing 28. In a preferred embodiment, the safety door sensor is an electrical, a mechanical or an optical sensor, and is configured to recognize whether the safety door 30 is open. The transformer 14 is also preferably connected electronically to the safety door sensor, and is configured to not generate voltage while the safety door 30 is still open. In one preferred embodiment, a two-handed safety switch acts as the mechanical sensor, and the transformer is configured to only generate voltage when the safety switch has been activated, locking the safety door 30 in the process.

In a preferred embodiment, most of the surface treatment technique is controlled via a control panel 32. Parameters such as the voltage applied by the transformer 14, the air velocity of the air blown by the air blower 18, the electrode 10 geometry, the distance between the electrodes 10, and the rotational speed of the fixture base 24 would preferably be controlled by an operator from the outside of the apparatus, or at a remote location. These parameters are variable based on the specific geometry and chemical makeup of the throttle body structure 26. Specific values are well-known in the art. Further, other mechanical aspects of the apparatus may be controlled via the control panel 32, such as the position of the safety door 30 or movement of the pneumatic slide 22.

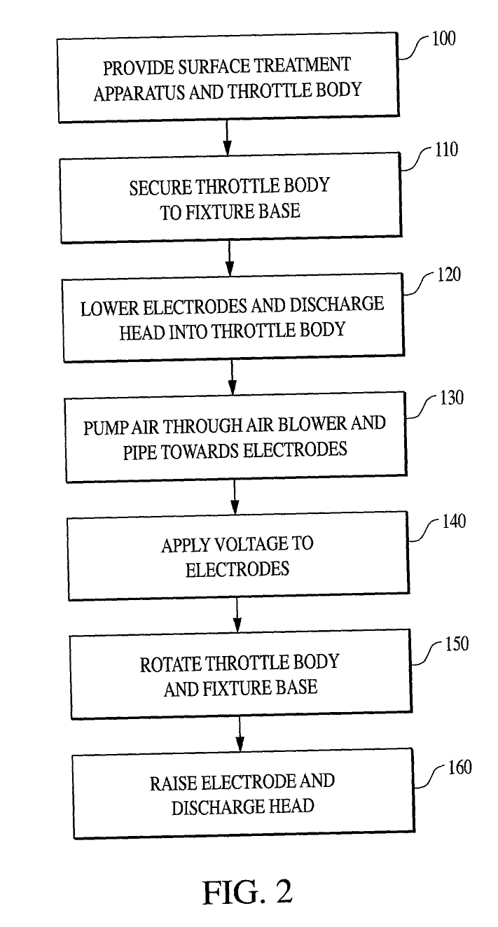

With the apparatus as described above, the surface of a throttle body structure can be treated. A preferred method according to the present invention is shown in FIG. 2. The apparatus according to the present invention is provided at Box 100. The throttle body structure 26 is placed on the fixture base 24 inside the housing 28 at Box 110. Clamps, positioning locks, or other means of securing the throttle body structure 26 to the fixture base 24 are employed. The safety door 30 of the housing 28 should preferably be closed before proceeding, to protect the operator from the voltage used in the treatment process. Preferably, the safety door sensor prevents the treatment from going further unless the safety door 30 is closed.

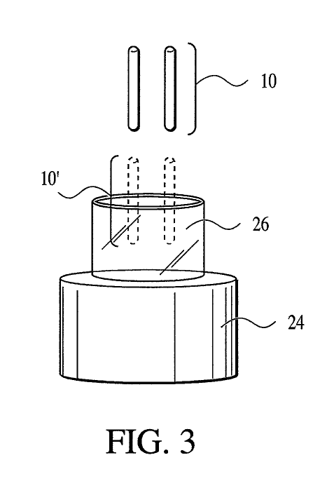

When the treatment is ready to begin, the electrodes 10 are lowered via the pneumatic slide 28 and the discharge head 12 at Box 120. The electrodes 10 and the discharge head 12, starting in a home position, should be lowered into an engaged position in the center of the throttle body structure 26. This is shown in FIG. 3, where the electrodes 10 are depicted in the home position and in the engaged position (at 10′). After the electrodes 10 are lowered into the throttle body structure 26, the air blower 18 blows air through the air pipe 20 and between the electrodes 10 at Box 130. The transformer 14 applies voltage to the electrodes 10 at Box 140 to create the corona. The air blown between the electrodes 10 at Box 130 is directed towards the corona. This air stream blows the electrical arcs of the corona out towards the throttle body structure 26. The fixture base 24 and throttle body structure 26 are rotated at Box 150 to give equal treatment to all areas of the throttle body structure 26. Preferably, the throttle body is rotated once during treatment, one revolution preferably occurring within about 5 seconds.

Once the treatment is complete, the electrodes 10 and the discharge head 12 are preferably returned to their home position at Box 160. The throttle body structure 26 can then be removed from the fixture base 24.

The embodiments shown in the present invention are to be considered as illustrative and not restrictive, and the invention is not to be limited to the details given herein, but may be modified within the scope of the following claims.

1. An apparatus for surface treatment of a throttle body structure, comprising:
a first electrode;
a second electrode;
a transformer electrically connected to said first electrode and said second electrode, said transformer configured to generate voltage between said first electrode and said second electrode;
a fixture base, said fixture base configured to rotate around a central axis; and
a housing surrounding said first electrode, said second electrode, said transformer, and said fixture base.

2. The apparatus of claim 1, wherein said transformer is electrically connected to both said first electrode and said second electrode through a discharge head, said first electrode spaced from said second electrode, said discharge head connected to said transformer through a high voltage power line, said discharge head is attached mechanically to said housing via a pneumatic slide, and said discharge head configured to attach both said first electrode and said second electrode to said high voltage power line.

3. The apparatus of claim 2, further comprising:
an air blowing unit attached to the outside of said housing; and
an air pipe attaching the air blowing unit to said discharge head, said air pipe configured to direct air towards the first electrode and second electrode.

4. The apparatus of claim 2, further comprising a control panel electronically connected to said transformer and said pneumatic slide.

5. The apparatus of claim 4, wherein said housing further comprises a safety door and a safety door sensor, said safety door electronically attached to said control panel.

6. The apparatus of claim 2, wherein said discharge head is configured to allow the spacing between said first electrode and said second electrode to be adjusted.

7. The apparatus of claim 6, wherein said control panel is adapted to control the spacing between said first electrode and said second electrode on said discharge head.

8. The apparatus of claim 4, wherein said control panel is configured to adjust the voltage output of said transformer.

9. The apparatus of claim 1, wherein said fixture base further comprises a means for securing said throttle body structure.

10. The apparatus of claim 9, wherein said means for securing said throttle body is selected from the group consisting of at least one positioning lock, at least one clamp, or a combination thereof.

11. The apparatus of claim 2, wherein said pneumatic slide acts in a direction perpendicular from said fixture base.

12. A method for surface treatment of a throttle body structure comprising:
providing a surface treatment apparatus comprising a housing, a first electrode inside said housing, a second electrode inside said housing, a discharge head inside said housing connected to both said first electrode and said second electrode, a transformer electrically connected to said discharge head, an air blower attached to said discharge head via an air pipe, a pneumatic slide attached to said housing and said discharge head, a fixture base inside said housing, and a control panel connected to said pneumatic slide and said transformer;
providing a throttle body structure;
securing said throttle body structure to said fixture base;
controlling said pneumatic slide with said control panel wherein said discharge head, said first electrode, and said second electrode are lowered from a home position and descend into an engaged position such that both said first electrode and said second electrode are in the center of said throttle body structure;
pumping air through said air blower and said air pipe towards said first electrode and said second electrode;
applying voltage from the transformer to the electrodes;
rotating said fixture base and said throttle body; and
returning said discharge head, said first electrode, and said second electrode to said home position.

13. The method of claim 12, wherein said first electrode and said second electrode comprise a material selected from the group consisting of: tungsten, aluminum, stainless steel, and a combination thereof.

14. The method of claim 13, wherein said first electrode and said second electrode have a shape selected from the group consisting of: cylindrical bars, cylindrical bars with rounded ends, cylindrical bars with pointed ends, spikes, and hooks.

15. The method of claim 12, wherein the voltage applied is sufficient to create a corona between the two electrodes.

16. The method of claim 12, wherein the voltage applied is between about 8 kV and about 200 kV.

17. The method of claim 16, wherein the voltage applied is about 12 kV.

18. The method of claim 12, wherein the fixture base has a maximum rotational speed of about 72 degrees/second.

19. The method of claim 12, said surface treatment apparatus further comprising a safety door in said housing and a safety door sensor in said housing configured to detect whether said safety door is open or closed, said method further comprising verifying that said safety door is closed, said step previous to said step of controlling said pneumatic slide.
